(19) United States
(12) Patent Application Publication
(10) Pub. No.: US 2026/0087946 A1
(43) Pub. Date: Mar. 26, 2026

(54) PERSONALIZABLE AND ENTERTAINING LABEL FOR BOTTLES

(71) Applicants: Samir Abi-Atme, Princeton, NJ (US); Marina Abi-Atme, Princeton, NJ (US); Sophia Abi-Atme, Princeton, NJ (US); Beatrice Abi-Atme, Princeton, NJ (US); Athena Abi-Atme, Princeton, NJ (US)

(72) Inventors: Samir Abi-Atme, Princeton, NJ (US); Marina Abi-Atme, Princeton, NJ (US); Sophia Abi-Atme, Princeton, NJ (US); Beatrice Abi-Atme, Princeton, NJ (US); Athena Abi-Atme, Princeton, NJ (US)

(21) Appl. No.: 19/337,112

(22) Filed: Sep. 23, 2025

Related U.S. Application Data
(60) Provisional application No. 63/698,725, filed on Sep. 25, 2024.

(51) Int. Cl. G09F 3/00; B65D 23/08; G09F 3/02; G09F 3/10

(52) U.S. Cl. CPC G09F 3/0297; B65D 23/085; G09F 3/10; G09F 2003/0208; G09F 2003/0239; G09F 2003/0241; G09F 2003/0273

(57) ABSTRACT

A reversible label for use with a bottle is disclosed. The label includes a strip of flexible material having a personalized side and a commercial side. The personalized side may include an identifier portion, message portion, QR portion, or game portion. The commercial side may include commercial indicia, such as a logo, producer information, or contents information. A bottle-side strip of attachable material is provided at a second end of the strip for securing the label to the bottle. An opposed first end of the strip includes releasable strips of material on both the personalized side and the commercial side, enabling the strip to be reversibly wrapped around the bottle to selectively display either the personalized side or the commercial side.

### CROSS-REFERENCE TO RELATED APPLICATIONS

This application claims the benefit of U.S. Provisional Patent Application Ser. No. 63/698,725 filed on Sep. 25, 2024, which is incorporated by reference herein in its entirety.

### FIELD OF THE INVENTION

The present invention relates generally to bottle identification devices, and more particularly, to a reversible label configured for attachment to a water or beverage bottle, wherein a first side may include personalizable indicia such as names, messages, QR codes, or games, and a second side may include commercial indicia such as logos, producer information, or product contents. The invention further relates to devices and systems that allow a user to selectively expose either side for purposes of identification, personalization, entertainment, or branding for providing individual personalization and entertainment on a water or beverage bottle.

### BACKGROUND OF THE INVENTION

Bottles, such as, for example, plastic bottles are useful containers for carrying a variety of liquids. The bottles typically have a label surrounding an outer surface of the bottle for displaying commercial information such as the name of the liquid product, the products composition, manufacturer information and the like. Such labels are usually fixed and non-personalizable, and they primarily serve the commercial producer rather than the individual user.

These labeled bottles may be used indoors. For example, in an office, meetings, parties, gatherings, etc. or taken outside. For example, to sports, picnics, gatherings, etc. to supply liquid to a user as needed. For example, when exercising, it is often necessary to have a supply of liquid at hand to replenish lost fluids. In the above-described situations, there are many people with their beverage bottles in the same area. This creates circumstances in which multiple identical or nearly identical bottles may be present at once.

Problems may arise when multiple bottles are being used in the same area and are from the same manufacturer or producer. Identifying which bottle belongs to which owner can be confusing as the bottles are picked up and put down randomly. This can result in one bottle owner not knowing exactly which bottle is owned by them as opposed to another person, highlighting the need for a way to make bottles distinguishable. Confusion of ownership can create both inconvenience and potential health risks.

In the case of bottles being mixed among the people, the bottle owner would throw his or her bottle away and grab a new one. This results in waste of beverage and plastic bottles. Thereby contributing to more plastic waste in the environment. Such waste is economically inefficient and environmentally undesirable.

An unhealthy situation may arise should one bottle owner inadvertently pick up and drink from another owner's bottle. Viruses and diseases may be transmitted, and the original owner may become sick from drinking from another owner's bottle. This risk is particularly significant in group settings, schools, athletic events, or workplaces where shared spaces are common.

Furthermore, on occasion, a bottle owner may become bored and look for a form of entertainment. Conventional bottle labels provide no mechanism for personal engagement, entertainment, or social interaction, leaving a gap in user experience.

Accordingly, there is need for a solution to at least one of the aforementioned problems. For instance, there is an established need for a personalizable or entertaining label for use with a bottle, to make the bottle readily distinguishable from others. There is also a need for a label that not only aids in identification but can also provide a means of communication, social interaction, or simple amusement, thereby serving both practical and recreational purposes.

### SUMMARY OF THE INVENTION

The present invention is directed to a personalizable and entertaining, reversible label for use with a bottle to make the bottle distinguishable and to provide a display for personalization and entertainment. The reversible label includes a strip of flexible material having personalizable indicia imparted to a first side of the strip of flexible material. A second side of the strip of flexible material is provided with commercial or other indicia. A strip of attachable material is provided on one end of the strip of flexible material to secure the reversible label to a bottle. An opposed end of the strip of flexible material includes releasable strips of material on both the first and second sides to allow the label to be selectively wrapped and re-wrapped to expose either side as desired by the user.

In a first implementation of the invention, a reversible label for displaying personalizable and entertaining fields for a bottle owner is disclosed, the reversible label comprising:
a strip of flexible material having a first side, a second side, a first end and a second end, said first side including personalization indicia;
a first releasable strip of material provided on said first side of said strip of flexible material;
a second releasable strip of material provided on said second side of said strip of flexible material; and
a strip of attachable material provided on said second end.

In a second aspect, the personalization indicia on the first side of the strip of flexible material may include an ID portion.

In another aspect, the ID portion may include a first box imparted on the first side of the strip of flexible material.

In another aspect, the personalization indicia on the first side of the strip of flexible material may include a message portion.

In another aspect, the first side of the strip of flexible material may include an entertaining field. configured as a personal or social interaction feature.

In another aspect, the message portion may include a second box imparted on the first side of the strip of flexible material.

In another aspect, the message portion may include a lucky number image imparted to the first side of the strip of flexible material.

In another aspect, the lucky number image may be located above the second box.

In another aspect, the message portion may include horizontal lines located within the second box.

In another aspect, the first side of the strip of flexible material may include a QR code portion.

In another aspect, the QR code portion may include a pre-printed QR code.

In another aspect, the first side of the strip of flexible material may include a game portion.

In another aspect, the game portion may include a pre-printed tic-tac-toe marking or other simple game field.

In another aspect, the second side of the strip of flexible material may include commercial indicia.

In another aspect, the commercial indicia may include a commercial logo.

In a second implementation of the invention, a bottle having a reversible label is disclosed, the bottle comprising:
a bottle including a body portion having an outer surface;
a reversible label reversibly wrapped around the outer surface of the body portion of the bottle, the reversible label including a strip of flexible material having a first side,
a second side, a first end and a second end, said first side including personalization indicia;
a first releasable strip of material provided on said first side of said strip of flexible material;
a second releasable strip of material provided on said second side of said strip of flexible material; and
a strip of attachable material provided on said second end of said strip of flexible material and secured to said outer surface of said bottle.

In a second aspect, the personalization indicia on the first side of the strip of flexible material may include an ID portion.

In another aspect, the personalization indicia on the first side of the strip of flexible material may include a message portion.

In another aspect, the first side of the strip of flexible material may include a QR code portion.

In another aspect, the first side of the strip of flexible material may include a game portion.

In another aspect, the second side of the strip of flexible material may include commercial indicia.

In a third implementation of the invention, a method of alternately displaying personal and commercial information on an outer surface of a bottle is disclosed, the method comprising;
providing a bottle including a body portion having an outer surface;
a reversible label reversibly wrapped around the outer surface of the body portion of the bottle, the reversible label including a strip of flexible material having a first side, a second side, a first end and a second end, said first side including personalization indicia;
a first releasable strip of material provided on said first side of said strip of flexible material;
a second releasable strip of material provided on said second side of said strip of flexible material; and
a strip of attachable material provided on said second end of said strip of flexible material and secured to said outer surface of said bottle;
wrapping said strip of flexible material around said outer surface of said bottle in a first direction;
securing said strip of flexible material around said bottle by adhering said first releasable strip of material to said strip of flexible material to expose said first side of said strip of flexible material.

In a second aspect, the method further includes releasing the first releasable strip of material from the strip of flexible material, wrapping the strip of flexible material in an opposite direction around the bottle and securing the strip of flexible material with the second releasable strip of material to expose the second side.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents top, front isometric view of a label for use in personalizing a water bottle, affixed to a water bottle, in accordance with an illustrative embodiment of the present invention;

FIG. 2 presents a top, front isometric view of the label for use in personalizing a water bottle illustrated in FIG. 1 and wrapped around the water bottle in a first or initial direction;

FIG. 3 presents a top, front isometric of the label for use in personalizing a water bottle, similar to FIG. 1, immediately prior to being wrapped around the water bottle in a second direction;

FIG. 4 presents a top, front isometric view of the label for use in personalizing a water bottle being wrapped around the water bottle in the second direction; and

FIG. 5 presents a top, front isometric view of the label for use in personalizing a water bottle fully wrapped around the water bottle in the second direction.

Like reference numerals refer to like parts throughout the several views of the drawings.

### DETAILED DESCRIPTION

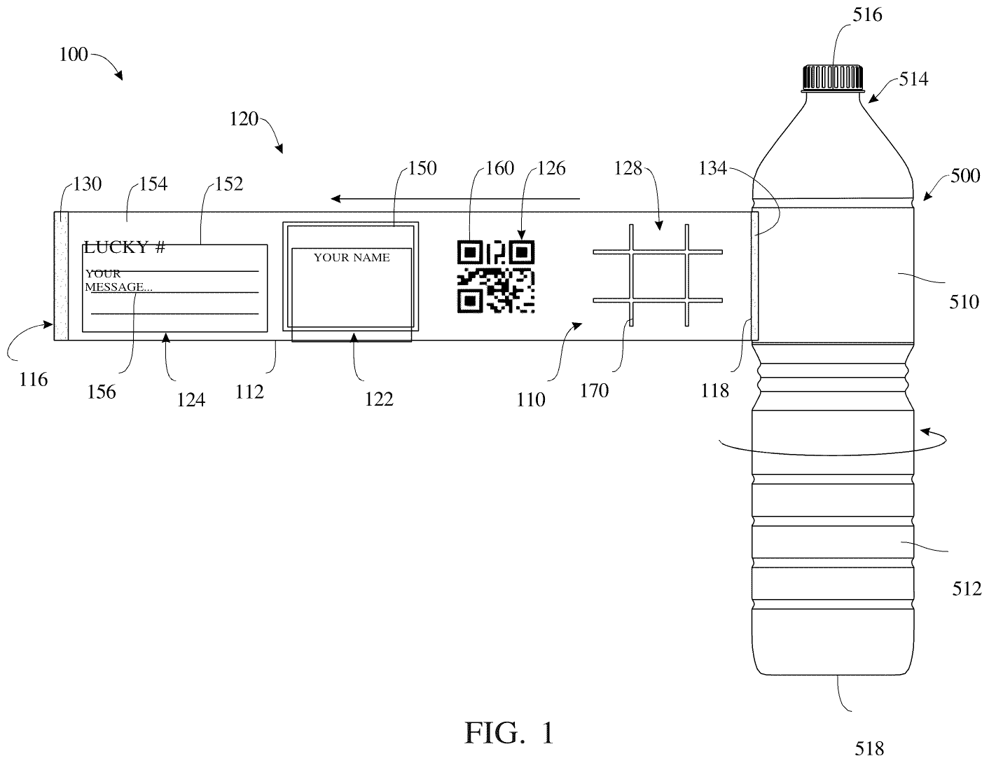

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. As otherwise used herein, the term “comprising” can also encompass the terms “consisting essentially of” and “consisting of”. In addition, it is expressly contemplated that all features described herein may be implemented individually or in any combination, unless otherwise expressly limited by the claims. Certain embodiments may omit one or more elements while still falling within the scope of the inventive concepts. For example, either side of the reversible label may be provided with indicia, without indicia, or with partial indicia, and the disclosure is to be read broadly to encompass blank, writable, or undecorated embodiments as well as pre-printed embodiments. Furthermore, references to specific attachment mechanisms, materials, or indicia are intended to encompass all known and functionally equivalent alternatives that would be recognized by a person of ordinary skill in the art.

Shown throughout the figures, the present invention is directed toward a personalizable and entertaining, reversible label which can be attached to a bottle to aid a user in distinguishing the user's bottle from other user's bottles as well as providing a source of entertainment and a social aspect. In certain embodiments, the reversible label (100) may also present a blank, writable surface free of pre-printed designs to enable direct, user-supplied customization. In other embodiments, the label (100) may provide only commercial indicia, only personal indicia, or any combination thereof, thereby enabling a wide spectrum of uses ranging from brand marketing to individualized bottle ownership. In addition to personalization and entertainment, the reversible label (100) may further function as an information carrier, permitting medical, safety, or emergency contact information to be displayed. The reversible nature of the label (100) allows it to alternately serve as a commercial branding tool, a personal identifier, or a clean slate surface, depending on user or manufacturer preference.

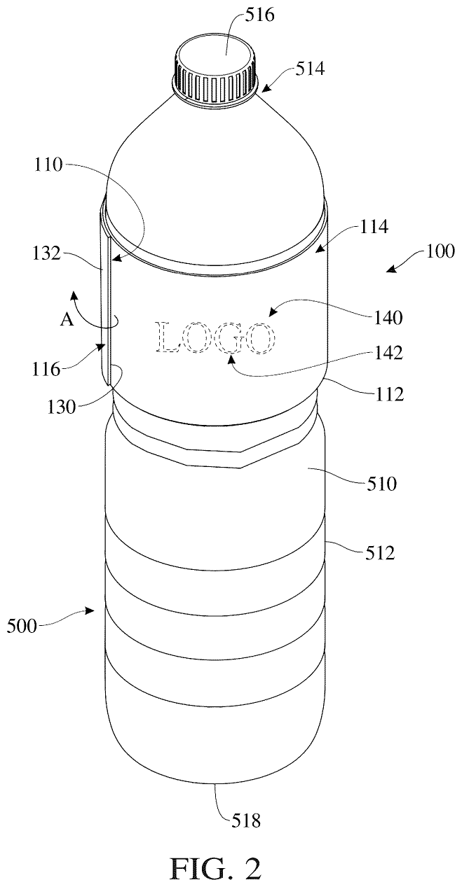

Referring to FIGS. 1-5, and initially with regard to FIGS. 1 and 2, a reversible and individually personalizable and entertaining label for use with bottle, hereinafter reversible label 100, is illustrated in accordance with an exemplary embodiment of the present invention. As shown, the reversible label 100 generally includes a first or personalized side 110 (FIG. 1) on a strip of flexible material 112 which can be individually marked up to reflect the identity and whims of a specific individual. The flexible strip of material 112 has a second or commercial side 114 which may contain specific commercial identifiers as discussed hereinbelow (FIG. 2). The strip of flexible material 112 of the reversible label 100 has a releasable or first end 116 and an attached or second end 118 which is attached to a bottle, such as, for example bottle 500. In alternative embodiments, either the personalized side 110 or the commercial side 114—or both—may be provided as blank writable surfaces free of pre-printed indicia, thereby allowing a user or manufacturer to determine the content post-production. The strip of flexible material 112 may further be configured to receive additional overlays, stickers, digital scannable tags, or erasable/reusable coatings to expand the range of personalization. The ends 116 and 118 may also include different configurations such as tapered edges, reinforced portions, or protective laminates to improve durability and ease of reversal.

The reversible label 100 is particularly suited for use with a typical bottle 500 such as, for example, a flexible plastic water bottle. The reversible label 100 is provided for use on an outer surface 510 of a body portion 512 of the bottle 500. Generally, the body portion 512 of the bottle 500 has an open top end 514 covered by a removable cap 516 and a closed bottom end 518. More particularly, the reversible label 100 is reversibly wrappable around the body portion 512 of the bottle 500 and releasably attachable to the outer surface 510 of the body portion 512 of the bottle 500 to alternately display the personalized side 110 of the reversible label 100 and the commercial side 114 of the reversible label 100 as discussed hereinbelow. In certain embodiments, the reversible label 100 may instead or additionally be employed with a wide range of containers, including rigid reusable bottles, insulated bottles, collapsible bottles, sports drink bottles, baby bottles, medical solution bottles, and food storage containers. The outer surface 510 may be cylindrical, faceted, or irregular, and the flexible strip 112 may be configured to accommodate such variations. Furthermore, either side of the reversible label 100 may be displayed as a blank writable surface to allow the user to record content directly on the bottle 500 without pre-printed indicia. The reversible label 100 may also be dimensioned or fabricated to cover only a portion of the bottle 500, or to wrap circumferentially around its entirety, depending on design or marketing preferences.

With specific reference to FIG. 1, in order to help identify a specific bottle 500 with a particular user or owner, the personalized side 110 of the reversible label 100 includes a variety of personalization indicia 120 imparted to the personalized side 110 and which can be marked up or filled in by the user or owner to assist the owner in identifying his or her particular own bottle 500. The personalization indicia 120 generally includes a name or identifier (“ID”) portion 122. The ID portion 122 provides a place for an owner to print or write the owner's name as well as any other identifying characteristics such as, for example, the owner's address, phone number or phone numbers, email addresses, etc. This can be done with a pen or pencil or other type of marker. This ensures the owner can pick up and use the owner's own bottle 500 after having set the bottle 500 down amongst a number of other bottles 500. In alternative embodiments, the ID portion 122 may be left blank to permit later user entry, or it may be pre-printed with generic prompts, boxes, or symbols to guide personalization. The indicia 120 may also include erasable or reusable fields, such as dry-erase coatings, chalkboard-type coatings, or rewritable films, thereby enabling repeated use across multiple events. Furthermore, the indicia 120 may accommodate digital enhancements such as machine-readable barcodes, QR codes, or near-field communication (NFC) tags for electronic identification. The ID portion 122 may further be adapted to display non-user-specific information such as product batch number, expiration date, or safety instructions, thereby expanding functionality beyond personalization.

The personalized side 110 of the reversible label 100 may also include other personalization indicia 120 such as, for example, a personal message portion 124, a quick response code or “QR” portion 126 and a game portion 128. Other types of indicial portions in the form of personalization indicia 120 may also be provided such as, for example, a portion to add contact information of related parties such as family, doctors'names and phone numbers in case of emergency and the like. In further embodiments, the indicia 120 may be configured as blank fields intentionally devoid of pre-printed matter, thereby permitting later user customization or preserving a clean, undecorated aesthetic. The message portion 124 may be implemented with different writable technologies, including erasable surfaces, scratch-off coatings, or peel-and-replace stickers. The QR portion 126 may be substituted with other machine-readable or digital codes such as barcodes, RFID tags, or near-field communication (NFC) elements to facilitate electronic identification or smartphone interaction. The game portion 128 may include pre-printed or user-defined games, puzzles, or educational content, thereby enhancing the entertainment or social functionality of the reversible label 100. Additionally, the indicia 120 may be adapted to carry health-related data, safety warnings, or event-specific information (e.g., concert entry code, sporting team schedule), thereby broadening its application beyond casual personalization.

The personal message portion 124 on the personalized side 110 of the reversible label 100 provides a place for an owner to record a favorite number or numbers such as, for example, a luck number, birth dates, anniversary dates, and the like. The personal message portion 124 may also provide space for an owner to pre-record items such as, for example, an inspirational phrase, poem, prayer and the like or may be used on the spot to record other information such as, for example, other people's names and numbers, addresses, dates and the like. The personal message portion 124 may also be used to record a message to another person, for example the bottle owner may add a message such as, for example, “Enjoy your day!” and hand the unopened bottle to another person. This provides a positive social aspect to the reversible label 100. In additional embodiments, the message portion 124 may be configured as a blank writable surface free of pre-printed indicia, thereby offering maximum flexibility to the user. The message portion 124 may alternatively include structured prompts such as lined boxes, bullet points, or iconography to guide user input. The writable surface may further be treated with erasable or reusable coatings (e.g., dry-erase, chalkboard, or thermochromic layers) to allow temporary notes that can be updated or erased. The message portion 124 may also incorporate digital interaction features, such as a scannable QR code linking to a personalized video message, or an NFC chip storing a prerecorded greeting, thereby expanding the social and entertainment aspects. Moreover, the message portion 124 may serve functional purposes, such as recording health reminders, allergy alerts, hydration tracking, or dosage schedules, making the label suitable for both casual and medical applications.

The QR portion 126 on the personalized side 110 of the reversible label 100 may include an easily scannable QR code relating to the beverage brand web page. The game portion 128 on the personalized side 110 of the reversible label 100 is included to provide the owner of the bottle 500 a distraction or means to occupy time. The game portion 128 may include as simple or as complicated a game as desired by the owner. The game portion 128 may include a game played singly or with other people. In further embodiments, the QR portion 126 may instead or additionally include other machine-readable identifiers, such as barcodes, alphanumeric codes, radio frequency identification (RFID) tags, or near-field communication (NFC) chips, thereby enabling both analog and digital interactions. The QR portion 126 may be printed, embossed, laser-etched, or otherwise imparted to the label 100, or it may be left blank to preserve design simplicity until customized later. The game portion 128 may include pre-printed games such as tic-tac-toe, crossword puzzles, mazes, or connect-four, or may be configured as a blank game field on which users can create their own games. The game portion 128 may further be interactive with electronic devices, such as by scanning a QR code or NFC chip that links to an app, digital challenge, or augmented reality feature. Additionally, the game portion 128 may be tailored for educational purposes, including language learning, math puzzles, or health trivia, thereby broadening the functionality beyond entertainment alone.

As noted above, the reversible label 100 has a releasable or first end 116 and an attachable or second end 118. The releasable or first end 116 of the strip of flexible material 112 of the reversible label 100 is provided to alternately and reversibly be attached back onto the strip of flexible material 112 so as to expose either the personalized side 110 of the reversible label 100 or the commercial side 114 of the reversible label 100. The first end 116 of the flexible strip of material 112 includes a first releasable attachment mechanism or first strip of releasable material 130 on the first or personalized side 110 of the flexible strip of material 112 and a second releasable attachment mechanism or second strip of releasable material 132 (FIG. 2) on the second or commercial side 114 of the flexible strip of material 112. Both the first and second strips of releasable material 130 and 132, respectively, are releasably attachable back over the flexible strip of material 112 of the reversible label 100 as discussed in more detail herein below. In further embodiments, the releasable end 116 may employ various types of attachment mechanisms, including reusable adhesives, hook-and-loop fasteners, magnetic strips, snaps, or pressure-sensitive fasteners. The releasable attachment may also include multi-use coatings that allow for repeated opening and closing without loss of adhesion. In some configurations, the end 116 may be dimensioned to overlap partially or fully with the strip of flexible material 112 to enhance securement. The releasable end 116 may further be configured with reinforced or laminated portions to increase durability during repeated reversals. Moreover, either side 110, 114 exposed after reversal may be provided as a blank writable surface or decorated with indicia, thereby ensuring adaptability to a wide range of user or manufacturer needs.

The attachable or second end 118 of the reversible label 100 is intended to be fixedly attached to the bottle 500. Thus, the second end 118 of the reversible strip of flexible material 112 of the reversible label 100 also has a connector or bottle side strip of attachable material 134 for fixedly attaching the second end 118 of the reversible label 100 to the bottle 500. In a particular embodiment, the bottle side strip of attachable material 134 is provided on the personalized side 110 of the second end 118 of the strip of flexible material 112 of the personalized label 100. In additional embodiments, the bottle side strip of attachable material 134 may comprise pressure-sensitive adhesives, heat-activated adhesives, cold-seal adhesives, ultrasonic bonding materials, or mechanical fasteners such as snaps or rivets. The attachment may be permanent, semi-permanent, or replaceable depending on manufacturer requirements. In some cases, the second end 118 may be fused directly into the material of the bottle 500 during the manufacturing process, such as by thermal bonding, molding-in, or lamination, thereby integrating the label into the bottle structure itself. Alternatively, the second end 118 may be designed to be removably fixed, allowing the label to be transferred from one bottle to another. In still other embodiments, the strip 134 may be applied to either the personalized side 110, the commercial side 114, or both, thereby enabling flexible attachment orientations. Furthermore, either side of the reversible label 100 exposed after attachment may be configured as a blank writable surface free of indicia, ensuring compatibility with both personalized and commercial applications.

With specific reference to FIG. 2, the commercial side 114 of the strip of flexible material 112 of the reversible label 100 can include commercial indicia 140 specifically related to the producer or seller of a product (not shown) contained within the bottle 500. The commercial indicia 140 may include a company logo 142 or other information associated with the producer or composition of the contents of the product contained within the bottle 500. For example, the commercial indicia 140 may include a company physical or email address, a company phone number or parent company information and/or may include contents information such as ingredients, percentages of the ingredients in the product, calories, etc. In certain embodiments, the commercial side 114 may instead or additionally comprise a blank writable surface for subsequent customization, thereby enabling dual use as either a marketing or personalization field. The commercial indicia 140 may also include regulatory disclosures, certification marks, barcodes, expiration dates, or batch numbers. In some embodiments, the commercial indicia 140 may be dynamically alterable, such as through erasable coatings, removable overlays, or digital tags (QR, RFID, NFC) that provide updated content when scanned. The commercial indicia 140 may further serve promotional purposes by including contest codes, prize entries, loyalty program identifiers, or interactive media links. In still other variations, the commercial side 114 may be configured with sustainability messaging, recycling instructions, or health warnings, thereby broadening compliance and marketing applications.

In a preferred embodiment, the ID portion 122 of the reversible label 100 includes an area defined by a pre-printed first box 150 on the personalized side 110 of the reversible label 100. The first box 150 provides a defined location for recording personal identification data. It should be noted that all pre-printed elements on the personalized and commercial sides 110 and 114, respectively, can be imparted to the respective sides by ink printing, laser printing, embossing, etc. In alternative embodiments, the first box 150 may be omitted entirely, leaving a blank writable surface for unrestricted personalization. The defined area may also be shaped in different geometric configurations (e.g., circles, ovals, icons, or stylized frames) to match branding or aesthetic preferences. The first box 150 may further incorporate structured guides, such as lined fields, shaded regions, or icons, to assist users in entering identification information. The first box 150 may additionally be enhanced with special coatings, including erasable films, scratch-off layers, holographic overlays, or protective laminates, to increase durability and prevent tampering. In still other embodiments, the ID portion 122 may be digitally interactive, comprising a machine-readable code, RFID tag, or NFC element embedded within or adjacent to the first box 150, thereby linking the label to electronic identification or verification systems.

The message portion 124 on the personalized side 110 of the reversible label 100 may include a pre-printed second box 152 having a lucky number or “lucky #” image 154 located above the second box 152 and pre-printed horizontal lines 156 located within the second box 152. As noted above, the message portion 124 gives the bottle owner a place to record non-identifying subject matter. In certain embodiments, the second box 152 and associated graphics may be omitted, thereby leaving a blank writable surface to maximize user flexibility. Alternatively, the message portion 124 may include different types of prompts or symbolic cues, such as inspirational icons, affirmations, or customizable stickers. The pre-printed horizontal lines 156 may be replaced with dotted lines, grids, or shaded areas to accommodate handwriting, sketches, or drawings. The message portion 124 may also be configured with erasable or reusable coatings, allowing messages to be removed and rewritten repeatedly. In further embodiments, the lucky number image 154 may be replaced or supplemented by other personalization symbols, such as astrological signs, motivational quotes, or cultural icons, depending on market preferences. Moreover, the message portion 124 may incorporate digital enhancements, such as scannable codes or NFC elements linking to a user's digital note, playlist, or motivational message.

The QR portion on the personalized side 110 of the reversible label 100 may include a pre-printed QR code 160. The QR code 160 may relate to the characteristics of the bottle 500 or may be chosen to direct the user to other matters as described hereinabove. Alternatively, the pre-printed QR code 160 can relate to a game or prize associated with the bottle 500. In certain embodiments, the QR portion may instead be provided as a blank writable surface until a code is later applied by the user or manufacturer. The QR code 160 may also be dynamic, comprising variable or erasable printing technologies (e.g., thermochromic, photochromic, or e-ink) that allow the displayed code to change over time. In addition to QR codes, the portion may accommodate other machine-readable technologies, including barcodes, matrix codes, radio-frequency identification (RFID) tags, or near-field communication (NFC) elements. The QR portion may further serve commercial and functional purposes, such as linking to product authentication sites, nutritional or safety databases, promotional offers, or refill/recycling instructions. In further embodiments, the QR code 160 or equivalent identifier may be customized per user, linking to personal webpages, social media accounts, or cloud-based storage, thereby expanding its social and entertainment value.

The game portion 128 on the personalized side 110 of the reversible label 100 may include a pre-printed game such as, for example a pre-printed tic-tac-toe board 170. The owner of the bottle 500 may use the tic-tac-toe board 170 to while away the time with another person. While not specifically shown, other games such as, for example, connect four and the like may also be pre-printed in the game portion 128 of the reversible label 100. In alternative embodiments, the game portion 128 may instead be provided as a blank writable field to allow the user to create custom games or activities, thereby increasing reusability and personalization. The game portion 128 may also comprise educational content such as arithmetic problems, vocabulary puzzles, or science trivia, broadening functionality beyond entertainment. In further embodiments, the game portion 128 may incorporate interactive digital elements such as QR codes, NFC tags, or augmented reality markers that link to mobile or web-based games. Still other embodiments may include erasable or reusable surfaces (e.g., dry-erase, chalkboard, or scratch-off coatings), thereby permitting multiple rounds of play without replacement. Additionally, the game portion 128 may be tailored to social interaction or health promotion, such as hydration challenges, team-building prompts, or collaborative puzzles, thereby positioning the reversible label 100 for both recreational and functional uses.

The strip of flexible material 112 comprising the reversible label 100 may be formed from a variety of flexible materials such as, for example, polymers, like polyvinylchloride, paper, other polymers or plastics, etc. The material chosen for manufacturing the reversible label 100 should be such that it readily accepts marking from a variety of sources such as, for example, ink, gel or grease pens, pencils, crayons, or even scratch off, etc. Also, the material could be made in such a manner that the actual water or beverage contained in the bottle could be used as a marking source. The strip of flexible material 112 may also be formed from a single or a variety of colors, images, patterns, etc. In alternative embodiments, the flexible material 112 may include biodegradable or compostable polymers such as polylactic acid (PLA) or starch-based films, thereby enhancing environmental sustainability. The material may also be formed from recyclable composites or laminated fabrics for durability in reusable bottles. In still further embodiments, the strip 112 may incorporate erasable or rewritable coatings such as dry-erase laminates, thermochromic films, or chalkboard-type finishes, enabling repeated customization. The flexible material 112 may also be embedded with digital functionality such as conductive inks, RFID threads, or near-field communication (NFC) circuits, thereby allowing the label to interact electronically with external devices. Additionally, the strip may be textured or embossed to provide tactile features for visually impaired users, further broadening the inclusivity of the reversible label 100. Moreover, the color and patterning of the material may be user-modifiable, such as through peel-and-stick overlays, scratch-off layers, or erasable dyes.

The first and second releasable strips of material 130 and 132 on the personalized and commercial sides 110 and 114, respectively, at the first end 116 of the strip of flexible material 112 of the reversible label 100 may be formed from a variety of easily releasable materials. Such materials may include weak adhesives, hook and loop fastener material and the like. The bottle side strip of attachable material 124 at the second end 118 of the strip of flexible material 112 is formed from a more permanent and stronger holding material such as, for example, strong adhesives, glues, etc. The bottle side strip of attachable material 124 may be formed from the types of adhesives commonly used by manufactures in attaching labels to bottles. Alternatively, the bottle side strip of attachable material 124 may be fused or otherwise permanently affixed to the outer surface 510 of the bottle 500. In further embodiments, the releasable strips 130, 132 may be configured using magnetic fasteners, reusable pressure-sensitive adhesives, or micro-suction films to allow repeated opening and closing cycles without degradation. The releasable connection may also incorporate mechanical interlocks such as snaps, clips, or sliding tracks for improved durability in rugged environments. The bottle side strip of attachable material 124 may additionally include heat-activated adhesives, ultrasonic welding films, cold-seal adhesives, or molded-in fasteners to integrate the label into the bottle during manufacture. In still other embodiments, the releasable strips 130, 132 and the bottle-side strip 124 may be made from biodegradable or recyclable adhesive systems to promote environmental sustainability. Furthermore, either the releasable strips or the bottle-side strip 124 may be provided in a configuration that leaves portions of sides 110, 114 as blank writable surfaces, ensuring that attachment functionality does not limit user personalization or commercial display options.

Turning now to FIGS. 2-5, and initially with regard to FIG. 2, in use, the reversible label 100 is initially wrapped around the outer surface 510 of the bottle 500 such that the commercial side 114 of the reversible label 100 is facing outward and the logo 142 is exposed for viewing. In this condition, the first releasable strip of material 130 on the personalized side 110 of the reversible label 100 is releasably connected to the strip of flexible material 112 to hold the reversible label 100 in position on the bottle 500. The second releasable strip of material 132 on the second or commercial side 114 of the reversible label 100 faces outward. In certain embodiments, when the commercial side 114 is outwardly displayed, the label 100 may be used for regulatory information, nutrition facts, promotional branding, or batch tracking. The outward-facing surface may also be configured as a blank writable field, allowing the user or manufacturer to selectively apply temporary or permanent indicia. In some cases, the releasable connection of strip 130 may be enhanced by magnets, micro-suction films, or reusable adhesives to increase securement during transport or use. The commercial-outward configuration may further integrate interactive features such as scannable codes, NFC tags, or augmented reality markers visible to others, thereby serving both marketing and social engagement functions. Additionally, the commercial side 114 may be tailored to different industries, such as medical bottles with dosage instructions, sports bottles with hydration tracking, or event bottles with sponsorship logos, ensuring broad applicability.

To reverse the reversible label 100 on the bottle 500 and expose the personalized side 110 of the reversible label 100 for viewing identification information, marking, playing games and the like, the first end 116 of the strip of flexible material 112 is grasped by the owner and the first end 116 pulled away from the outer surface 510 of the bottle 500 to release the first releasable strip of material 130 from the strip of flexible material 112. The first end 116 is pulled in the direction of arrow “A”. In certain embodiments, the release of strip 130 may be facilitated by ergonomic design features such as textured grips, pull tabs, or extended flanges that simplify user handling. The detachment process may also be assisted by magnetic or micro-suction systems, which allow repeated reversals without adhesive degradation. In further embodiments, the personalized side 110 revealed upon reversal may be configured as a blank writable surface, ensuring adaptability for users who prefer undecorated labels. Alternatively, the exposed side may present educational, medical, or safety indicia such as dosage reminders, allergy alerts, or hydration tracking fields. The reversal action itself may further serve as an interactive feature, for example, revealing a hidden message, code, or image when the label is flipped, thereby increasing both entertainment and functional value.

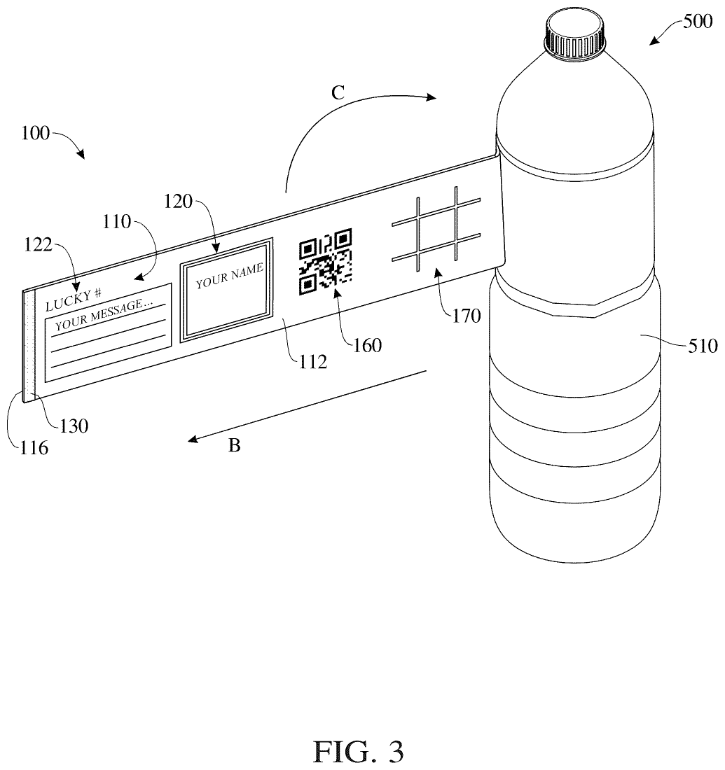

As best shown in FIG. 3, the strip of flexible material 112 of the reversible label 100 is pulled away from the body portion 512 of the bottle 500 in the direction of arrow “B” until the strip of flexible material 112 extends fully away from the body portion 510. The strip of flexible material 112 may be pulled such that it extends perpendicularly from the bottle 500. In this extended condition, the personalized side 110 of the reversible label 100 is exposed and may be marked as noted above. In particular, the reversible label 100 may be placed on a firm surface and the personalization indicia 120 and the ID portion 122 filled out. If previously filled out, the personalized side 110 is now exposed to be read as needed. Additionally, the QR code 160 is exposed to be scanned and the tic-tac toe marking 170 exposed to be played on. In certain embodiments, when the strip 112 is extended, the personalized side 110 may alternatively present a blank writable surface to accommodate user-supplied content. The extended condition may also enable easier interaction with features such as erasable fields, scannable codes, or tactile indicia for visually impaired users. The strip 112 may further be configured to temporarily lock in the extended position via detent, magnet, or friction fit to facilitate writing or scanning before reversal. In some embodiments, the extended state may reveal hidden or layered information, such as concealed promotional codes, health instructions, or interactive educational material. The extension process itself may additionally be employed as a gamified or interactive mechanism (e.g., pulling to reveal a riddle, prize, or augmented reality marker).

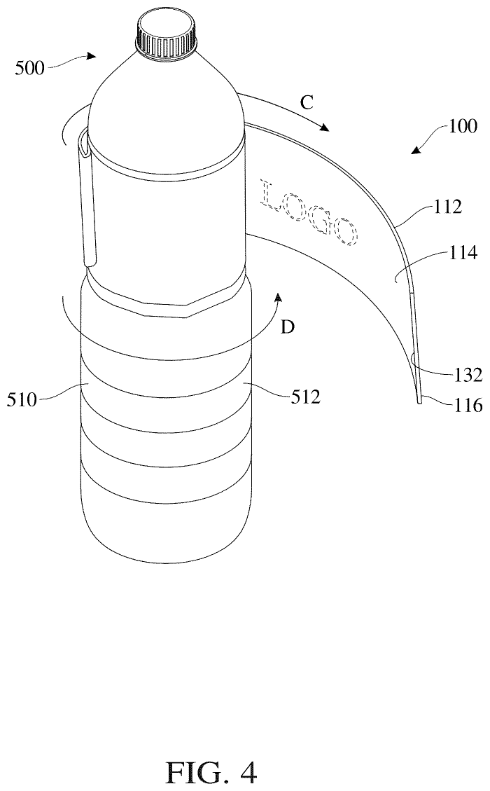

In order to fully reverse the reversible label 100 and expose the personalized side 110 of the reversible label 100, the reversible label 100 is pulled in the direction of arrows “C” (FIGS. 3 and 4) to wrap the reversible label 100 around the body portion 512 of the bottle 500 and against the outer surface 510 of the bottle 500. Turning the bottle 500 in the opposite direction of arrow “D” (FIG. 4) may assist the owner in reversing the reversible label 100 on the bottle 500. In certain embodiments, the reversal process may be aided by guide features such as alignment marks, grooves, or tactile ridges on the bottle 500 or the label 100, ensuring proper reattachment. The reversal may further employ assistive mechanisms such as magnetic alignment strips, spring tensioners, or low-friction coatings to simplify wrapping. In some cases, the reversible label 100 may be dimensioned to self-align when rewrapped, using elastic memory materials or pre-formed curvature to naturally return to a wrapped state. The personalized side 110 exposed after reversal may present either pre-printed indicia or a blank writable surface, thereby covering both decorative and undecorated embodiments. Additionally, the reversal step may trigger secondary functionality, such as revealing hidden promotional codes, activating a scannable element, or displaying safety information, thereby expanding both entertainment and commercial applications.

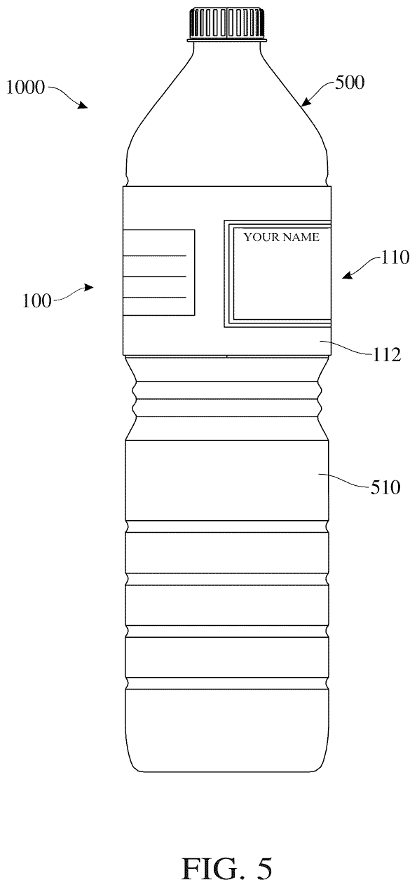

As shown in FIG. 4, the first end 116 of the strip of flexible material 112 of the reversible label 100 is wrapped around the body portion 512 of the bottle 500 until the strip of flexible material 112 lies flush against the outer surface 510 of the bottle 500 (FIG. 5). The second releasable strip of material 132, located on the commercial side 114 of the strip of flexible material 112, adheres to the personalized side 110 of the strip of flexible material 112 to hold the reversible label 100 in place around the bottle 500. In this manner, the personalized side 110 of the reversible label 100 is displayed for viewing and/or marking. The reversible label 100 together with the bottle 500 may form a personalizable water bottle 1000. In further embodiments, the adherence of strip 132 may be facilitated by magnetic, micro-suction, or reusable adhesive technologies, thereby improving repeated reversals without degradation. The securement may also be aided by mechanical or elastic retention features such as clips, bands, or form-fitting curvature built into the strip of flexible material 112. Once secured, the personalized side 110 may present pre-printed indicia or a blank writable surface, depending on user preference or manufacturer design. In some cases, the reversible label 100 may be configured to provide tactile or audible feedback (e.g., a click, snap, or vibration) when properly reattached, ensuring the user knows the label is securely fixed. Additionally, the secured configuration may activate secondary functionality, such as aligning a scannable element for digital interaction, displaying a hidden promotional code, or confirming product authenticity. In still other embodiments, the water bottle 1000 may be marketed as a multi-use personalization platform, suitable not only for beverages but also for medical, sports, or promotional industries.

While not specifically shown, it should be noted that the procedure may be reversed again pulling the first end 116 of the strip of flexible material 112 such that the second releasable strip of material 132 is pulled free of the strip of flexible material 112. The reversible label 110 can then be wrapped in reverse around the bottle 500 to again expose the commercial side 114 and thus the logo 142 (FIG. 2). In alternative embodiments, the reversal back to the commercial side 114 may instead expose a blank writable surface suitable for post-manufacture customization. The repeated reversal process may also be facilitated by durable attachment technologies such as reusable adhesives, magnets, or micro-suction films to withstand multiple cycles without loss of adhesion. In further embodiments, the commercial side 114 revealed upon reversal may be configured for regulatory compliance, authentication, or promotional purposes, such as displaying expiration dates, tamper-evident markings, or contest codes. Additionally, the reversal process may itself be designed to trigger interactive functionality, such as uncovering hidden graphics, activating a scannable code, or aligning augmented reality markers for digital engagement. In still other embodiments, the label 100 may be configured such that repeated reversals contribute to gamified or educational interactions (e.g., revealing sequential puzzles, trivia, or instructions), thereby broadening the use cases beyond simple branding.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents. It should further be understood that the embodiments disclosed herein are not mutually exclusive and may be combined as a whole or in part to achieve additional variations of the reversible label 100. Unless otherwise expressly stated, features described in connection with one embodiment may be applied equally to other embodiments. The invention expressly encompasses blank, undecorated, or unmarked label surfaces as well as surfaces bearing indicia, commercial content, or personalization. The invention also expressly covers future-developed attachment technologies, digital identification systems, or material compositions that provide equivalent functionality. Furthermore, references to particular materials, attachment methods, indicia types, or digital systems should not be construed as limiting, as the invention is intended to encompass all functional equivalents, foreseeable substitutions, and legally permissible extensions thereof.

What is claimed is:

1. A reversible label for a bottle, comprising:
a strip of flexible material having a personalized side and a commercial side;
a first end of the strip having a releasable attachment mechanism;
a second end of the strip having an attachable material for fixed connection to the bottle;
the strip being configured to reversibly wrap around an outer surface of the bottle to alternately expose one of the personalized side and the commercial side; and
wherein at least one of the personalized side and the commercial side is configured as a blank writable surface or a surface bearing indicia.

2. The reversible label of claim 1, wherein the personalized side comprises an identifier portion configured to receive at least one of a user's name, address, phone number, or email address.

3. The reversible label of claim 1, wherein the personalized side comprises a message portion configured to record at least one of a number, phrase, poem, prayer, or other message.

4. The reversible label of claim 1, wherein the personalized side comprises a QR portion including a QR code.

5. The reversible label of claim 1, wherein the personalized side comprises a game portion including a pre-printed game.

6. The reversible label of claim 5, wherein the game portion comprises a tic-tac-toe board.

7. The reversible label of claim 5, wherein the game portion comprises a connect four game.

8. The reversible label of claim 1, wherein the flexible strip comprises a material selected from the group consisting of polyvinylchloride, paper, and other polymers or plastics.

9. The reversible label of claim 1, wherein the releasable attachment mechanism comprises at least one of a weak adhesive and a hook-and-loop fastener material.

10. The reversible label of claim 1, wherein the bottle-side attachable material comprises at least one of a strong adhesive and a glue.

11. The reversible label of claim 1, wherein at least one side comprises indicia imparted by at least one of ink printing, laser printing, and embossing.

12. A method of using a reversible label attached to a bottle, the method comprising:
releasing a first end of a flexible strip of the label from the bottle;
reattaching the first end to secure the strip around the bottle.

13. The method of claim 12, wherein extending the strip exposes a QR code on the personalized side.

14. The method of claim 12, wherein extending the strip exposes a tic-tac-toe board on the personalized side.

15. A personalizable bottle system, comprising:
a bottle having an outer surface;
a strip of flexible material having a personalized side and a commercial side;
a first end of the strip having a releasable attachment mechanism;
a second end of the strip having an attachable material fixedly attached to the outer surface; and
wherein the strip is configured to reversibly wrap around the outer surface to alternately expose one of the personalized side and the commercial side and the bottle together with the reversible label forms a personalizable water bottle.

16. The personalizable bottle system of claim 15, wherein the commercial side displays commercial indicia including a company logo.

17. The personalizable bottle system of claim 15, wherein the commercial side displays contents information including at least one of ingredients and calorie content.

18. The personalizable bottle system of claim 15, wherein the commercial side displays producer information including at least one of a physical address, an email address, and a phone number.

19. The personalizable bottle system of claim 15, wherein the personalized side includes a message portion with a pre-printed box and horizontal lines.

20. The personalizable bottle system of claim 19, wherein the personalized side includes a lucky number image located above the pre-printed box.
